(19) United States
(12) Patent Application Publication
(10) Pub. No.: US 2004/0035916 A1
(43) Pub. Date: Feb. 26, 2004

(54) Process of connecting a heat exchanger tube to a manifold and tube especially made therefor

(76) Inventors: Morton Syslak, Haugesund (NO); Ed Morley, Toftlund (DK); Leiv Adne Folkedal, Kopernik (NO); Borg Bjorneklett, Gjovek (NO)

Correspondence Address: HARTMAN & HARTMAN, P.C., 552 EAST 700 NORTH, VALPARAISO, IN, 46383, US

(21) Appl. No.: 10/433,767

(22) PCT Filed: Dec. 5, 2000
(86) PCT No.: PCT/EP00/12297

(51) Int. Cl. B23K 31/02

(52) U.S. Cl. 228/183

(57) ABSTRACT

A process of brazing an end portion of a heat exchanger tube to a manifold, and a tube therefor comprising at least one fluid passage having an opening in the end portion. The process involves depositing a stop-off containing coating on at least part of the end portion of the tube, assembling the tube to the manifold by inserting the end portion of the tube through an opening in a wall of the manifold, and then brazing the tube to the manifold wall. The coating inhibits brazing material from entering the opening of the tube fluid passage.

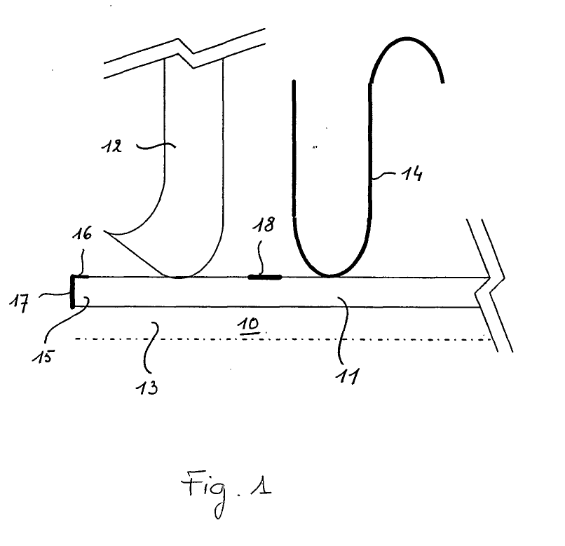

The invention relates to a process of connecting a heat exchanger tube to a manifold or the like by means of brazing. In heat exchangers, such as condensers, especially parallel-flow condensers, in air conditioning systems for cars it is customary to use two manifolds which are interconnected by a number of heat exchanger tubes. Between the parallel tubes fins are provided in order to improve the heat exchanging performance.

In the production of such heat exchangers the manifolds are provided with a number of holes, in which the end portion of the heat exchanger tubes must be positioned and connected in an air and liquid tight manner to the manifold. This connection is commonly obtained by means of brazing. For that purpose brazing material may be present on the surface of the manifold at least in the area around the holes.

During the controlled atmosphere brazing (CAB) operation, which is done in an oven, it frequently happens that brazing material flows over the surface of the heat exchanger tube and reaches the end section, which is provided with one or more openings for one of the heat exchanging fluids.

Dependent on the profile of the heat exchanging tube, this may result in complete sealing of a number of the openings or reducing the free surface of the opening or openings.

A further problem that can arise during the brazing is that liquid braze metal has a tendency to flow along the surface of the heat exchanger tubes. The preferred path for such liquid metal mobility appears to be related to topographical features on the surface which are an inevitable product of the tube forming process and are very difficult and expensive to completely eliminate. Such movement of liquid braze metal has an erosive effect on the aluminium tube surface (guttering) which can, in extreme cases, lead to actual perforation of the tube wall, resulting in rejection of the part.

A physical melt flow barrier solution to this problem is described in DE 19922673 but has the disadvantage of localised thinning of the tube wall thickness. This can have a converse effect in that braze material would have diminished wall thickness to consume, so rendering burn through easier to achieve.

It is therefore an object of the inventor to provide a process in which the above-mentioned problems are avoided.

This object is obtained in that prior to assembling and brazing the tube to the manifold at least part of the end portion of the heat exchanger tube has been crated with a stop-off composition. The application of the stop-off composition is made close to the tube end and across the flat faces of the tube in a linear manner (simulating the groove applied according to DE 19922673) or, in the case of prevention of braze metal ingress into the interior of the tube profile, to the tube end face (i.e. cut face).

Stop-off compositions are generally known in the art and the term is used here to designate compositions which when applied to a surface prevents that surface becoming wetted by molten flux and subsequently by molten braze metal during brazing or soldering.

By using such a stop-off composition in the way as described above it becomes possible to reduce or completely avoid the problem wholly or partially of obstructing the open ends of the heat exchange tubes or forming erosion grooves on the tube surface (guttering) as a result of the brazing process.

The invention also relates to a tube provided partly with a coating to be used in the process according to the invention.

Other advantages or characteristics of the invention will become clear from the following description, reference being made to the annexed drawing.

In this drawing there is schematically shown the connection between a heat exchanger tube and a manifold.

In the drawing there is shown one wall 11 of a tube 10, generally designated by means of its axis line. This tube 10 can be a traditional round tube, or as more customary in heat exchangers of this type it can be a multiple port tube, preferably made of aluminium and either produced by means of extrusion or another convenient way.

With 12 is indicated a wall of a manifold provided with a number of openings 13 (one shown) for accommodating the end portion of the heat exchanging tubes 10. Further there is schematically shown a fin 14 as is usually applied between two adjacent heat exchanger tubes in the heat exchanger.

In order to connect the heat exchanger tube 10 to the manifold 12 in a fluid- and airtight manner, the contact zone between the manifold opening 13 and the circumference part of the tube 10 is sealed by means of brazing or soldering. In practice the manifold surface is coated with a so-called braze cladding coating which upon heating to a sufficient temperature will provide the required brazing material in order to connect the tube to the manifold in a reliable way. This process is generally carried out in an oven in which a wholly assembled heat exchanger can be placed and heated in order to make all the required connections.

Prior to placing the assembly in the brazing oven, it is coated with a flux, the function of which is to remove oxides from the aluminium surfaces such that the braze metal referred to above can wet these aluminium surfaces.

In this process there is the risk that flux material is flowing along the outer surfaces of the tube either in the direction of its free end or to the other direction.

When flux material reaches the end portion 15 there is the risk that flux material flows around the cross-section area and wets the free opening of the heat exchanger tube enabling molten braze metal to flow to this region. Especially with small diameter holes there is the risk that the openings become partly or wholly obstructed, thereby reducing the efficiency of the heat exchanger.

In order to prevent this, the end portion 15 of the tube 10 is coated with a stop-off coating. This coating can either be applied to the end circumferential portion 16, the cross-section portion 17 or on both portions 16 and 17. In this way the flow of flux material is prevented from reaching the openings of the tube 11.

Similarly, the transverse marking of the tubes close to the ends prevents flow of braze metal beyond this unwettable barrier thereby hindering the development of guttering and eventual burn through by the erosive action of the braze metal.

Otherwise there might be a tendency of the flux material of the manifold to flow in the other direction, i.e. away from the end portion. In that case it may reach the contact zone with the fin 14 and influence the brazing of the fins 14 to the tubes 10. This may have negative influence on the corrosion characteristics of the connection between the fin and the tube which may result in an unwanted break through of the tube. Therefore a coating of stop-off composition may be applied to the circumference of the tube 10 at a location 18, thereby preventing the manifold-flux of reaching the in-area.

In the art a number of stop-off compositions are known. Suitable materials are e.g.:

1. Kluber UNIMOLY C220. This chemical is based on Molybden Sulfide which creates a non-sticking surface to various metals/alloys. Spray with ethanol propellant.

2. An Aqueous graphite mixture with the trade name of NEKOTE 35.

3. “Alu-Stop” Boron Nitride Aerosol is a coating material based on high-purity boron nitride showing a high specific surface. This coating shows a non-wetting behavior against most metals and can be applied directly onto the substrate to be protected. By the use of quick-drying components the coating can be put into service after a short drying time. Spray with ethanol propellant.

Other suitable materials includes fine graphite powder, e.g. a mark with a “soft” pencil, or mixtures consisting of medium-heavy engines oil e.g. SAE-30, naphtene, benzene or refractory oxides.

Application of the materials can be done in different ways, i.e. by means of coating by roll or brush coating, by spraying, especially for aerosol-base mixtures etc.

Most of the commercially available stop-off compositions described above lack good adhesion and wear characteristics. Thus the durability of such coatings is not sufficiently good to enable the pre-coated tubes to withstand shipping, handling and assembly damage which could render the coating irreparable damaged and hence dysfunctional.

As already disclosed in PCT/EP99/09162, acrylic based polymers, which are capable of acting as binders for the stop-off can offer the necessary durability to enable a pre-coated product to be supplied to heat exchanger assembly in an essentially unimpaired condition. It has further been demonstrated that these same polymers are able to pyrolyse in the brazing thermal cycle without impairment of the braze quality and performance of the braze process.

As previously stated, many compositions for braze stop-off rely on boron nitride which is a relatively expensive product or graphite. However most graphite based systems also exhibit poor adhesion and durability and so are unsuited to pre-coating ahead of packing, shipping and assembly. However, graphite, in the form of carbon black (pigment) is commonly incorporated into polymer binders in the manufacture of paints and this would offer a much cheaper and cost effective solution.

A further possible solution is the use of a coating which will inhibit wetting of the metal surface by the brazing flux. Such fluxes are typically based on potassium aluminium fluorides and a common trade name for such a product is Nocolok®. It is well known that such fluxes become ineffective in the presence of magnesium with as little as 0.4% of Magnesium in the aluminium substrate being sufficient to inhibit brazing. The function is that magnesium dissolving in the flux effectively raises the melting point of the resulting flux mixture so that the flux “dries out” and will not flow or wet the aluminium surface. It is therefore a further objective to use magnesium-containing compounds, preferably in the aforementioned acrylic binder, in a similar manner to the stop-off application described above. A suitable magnesium compound would be talc (magnesium, aluminium silicate) which is readily available and is commonly used in the paint industry. Other magnesium-containing compounds are also possible.

1. Process of connecting a heat exchanger tube to a manifold by means of brazing, characterized in that prior to assembling and brazing the tube to the manifold at least part of the end portion of the heat exchanger tube has been coated with a stop-off composition.

2. Process according to claim 1, characterized in that at least the circumferential part of the end portion of the tube is coated with a stop-off composition.

3. Process according to claim 1 or 2, characterized in that cross-section part of the end-portion of the tube is coated with a stop-off composition.

4. Process according to any one of the preceding claims, in which the tube is partly inserted into the manifold, characterized in that a stop-off coating is provided on the tube at both side with respect to the wall of the manifold.

5. Process according to anyone of the preceding claims, characterized in that the tube is a multi-port tube, preferably made out of aluminium or an aluminium alloy.

6. Process according to anyone of the preceding claims, characterized in that the stop-off composition is selected from the group consisting of molybden sulfide, aqueous graphite mixtures and boron nitride.

7. Process according to claim 6, characterized in that the stop-off composition is mixed with acrylic based polymers.

8. Process according to anyone of the claims 1-5, characterized in that the stop-off composition is a mixture of potassium aluminium fluoride and magnesium.

9. Process according to claim 8, characterized in that the magnesium is present as an inorganic compound.

10. Tube provided partly with a stop-off coating to be used in the process according to one of the claims 1-9.
